(19) United States
(12) Patent Application Publication
(10) Pub. No.: US 2024/0021853 A1
(43) Pub. Date: Jan. 18, 2024

(54) FUEL-CELL SYSTEM WITH EXHAUST-AIR MASS FLOW DETERMINATION

(71) Applicant: Robert Bosch GmbH, Stuttgart (DE)

(72) Inventors: Tobias Reinhard Ott, Leonberg (DE); Andreas Knoop, Esslingen (DE); Wolfgang Sander, Weissach (DE)

(21) Appl. No.: 18/254,908

(22) PCT Filed: Nov. 29, 2021
(86) PCT No.: PCT/EP2021/083317

§ 371 Date: May 30, 2023

(30) Foreign Application Priority Data
Dec. 1, 2020 (DE) 10 2020 215 093.1

(51) Int. Cl. H01M 8/0438; H01M 8/04111; H01M 8/04223; H01M 8/04746; H01M 8/0432

(52) U.S. Cl. CPC H01M 8/0441; H01M 8/04111; H01M 8/04231; H01M 8/04761; H01M 8/0435

(57) ABSTRACT

A fuel-cell system has at least one fuel cell, an oxidant line, a compressor, an exhaust-air line, a turbine, which is arranged in the exhaust-air line and is coupled to the compressor, an anode-purging line, which is connected to the exhaust-air line and has an anode-purging valve, and a control unit. The fuel-cell system is characterized in that a temperature-detecting unit is arranged at a turbine input, or upstream of the turbine input, for detecting the temperature of exhaust air flowing into the turbine, in that a pressure-detecting unit is coupled at least to the turbine input or a component lying upstream and is designed to detect a pressure of the exhaust air flowing into the turbine, in that the control unit is designed to ascertain a momentary mass flow of the exhaust air from the measured temperature of the exhaust air, the pressure upstream of the turbine and a specified turbine characteristic map, and in that the control unit is designed to activate the compressor and/or the turbine so as to achieve a minimum mass flow of the exhaust air.

### BACKGROUND

The present invention relates to a fuel-cell system having at least one fuel cell and a method for operating a fuel-cell system.

Vehicles are known in which electrical power is supplied by a fuel-cell system, through which prime movers are supplied. Hydrogen with an oxidant, typically oxygen from ambient air, is catalytically connected to water, wherein electrical power is supplied. The ambient air is provided to a cathode path of the fuel cells by means of an air convection system or air compression system. The air flow in the cathode path also transports the water produced by the reaction in the form of water vapor or fluidly in droplet form. Oxygen-depleted wet cathode exhaust air is discharged to the environment via an exhaust path.

In most cases, purge gas and water are still introduced from an anode path into this exhaust-air mass flow. In order to operate the anode side of a fuel cell safely, it is necessary to remove nitrogen that passes from the cathode to the anode during operation via a membrane-electrode unit as well as condensates that form. Then nitrogen removal is also called “purging” and water removal is called “draining.” Purging and draining usually occur on the cathode output side of the fuel cell. However, in principle, it cannot be prevented that undesired hydrogen might enter the exhaust-air line on the cathode output side in addition to the desired nitrogen and water. For safety reasons, it must be ensured that the average hydrogen concentration in the cathode exhaust air does not exceed a certain value, for example 4 vol. %. In order to ensure this, a sufficiently large amount of exhaust air must be available for the maximum possible amount of hydrogen during the purging and draining for the dilution thereof. In fuel-cell systems, air masses are typically measured according to the caloric principle or differential pressure principle. The necessity of not exceeding the specified maximum average hydrogen concentration in the exhaust air is a certification-relevant safety function.

### SUMMARY

A problem addressed by the invention is to propose an alternative fuel-cell system and a method for operating a fuel-cell system in which a sufficient dilution of hydrogen purged from an anode in an exhaust air is reliably achieved, even in the case of a defect in mass flow sensors or the like.

The problem is solved by a fuel-cell system having the features of the invention.

A fuel-cell system is proposed, having at least one fuel cell, an oxidant line, a compressor, an exhaust-air line, a turbine which is arranged in the exhaust-air line and is coupled to the compressor, an anode-purging line which is connected to the exhaust-air line and has an anode-purging valve, and a control unit. The fuel-cell system is characterized in that a pressure-detecting unit is coupled at least to the turbine input or a component lying upstream and is designed to detect a pressure of the exhaust air flowing into the turbine, in that the control unit is designed to ascertain a reduced mass flow of the exhaust air from the measured pressure upstream of the turbine, and a specified turbine characteristic map, and in that the control unit is designed to activate the compressor and/or the turbine so as to achieve a minimum mass flow of the exhaust air.

The at least one fuel cell could be a polymer electrolyte membrane (PEM) fuel cell. This is supplied with hydrogen or a gas comprising hydrogen on the anode side and with oxygen or a gas containing oxygen on the cathode side. During operation, water predominantly precipitates on the cathode, which enters the environment via the exhaust-air line. As the oxidant, air could in particular be suitable for operation in a vehicle, such that the oxidant line can in particular be an air line.

The anode-purging valve is activated by the control unit and, as needed, causes the anode to purge (so-called purging and draining). This means that the anode is flushed, in particular, so as to purge nitrogen and liquid water from the anode or components in fluid communication therewith. As a result, in addition to water and nitrogen, hydrogen is also introduced into the exhaust-air line. The anode-purging valve is located downstream of an anode output and could also be provided in a hydrogen recirculation path.

A core concept of the invention is based on carrying out, in addition to or as an alternative to a direct detection of an absolute mass flow of the incoming air for limiting a concentration of the hydrogen in the exhaust air, a determination of at least the reduced mass flow from other measured parameters, wherein a known characteristic map of the turbine is used for this purpose. The turbine characteristic map describes a performance of the turbine and illustrates a reduced mass flow over a pressure ratio of the turbine at a particular reference temperature. The turbine characteristic map can be influenced by various values including, among other things, the size of the turbine wheel, the turbine housing, the turbine geometry, and others. A so-called swallowing characteristic of the turbine is a function of the reduced mass flow, the expansion ratio, and the speed of the turbine. The reduced mass flow serves to facilitate the comparison of maps, which are created under different turbine input conditions.

By detecting at least a pressure at the turbine input or an upstream component in the exhaust-air line, an expansion ratio through the turbine can be determined knowing or assuming the ambient pressure and pressure drop in the exhaust-air system. Knowing a turbine speed, a momentary operating point on the turbine characteristic map could be identified based thereon. This allows the determination of the reduced mass flow. Knowing the temperature prior to entry into the turbine, the calculation of the actual mass flow is additionally enabled. However, knowledge of the reduced mass flow could be sufficient in order to ensure a minimum mass flow rate in the case of specified limits of a known fuel-cell system with known operating characteristics within the turbine characteristic map.

In a simple case, all required parameters could be measured. This consequently also includes measuring a pressure at a turbine output as well as the speed of the turbine. Parameters such as the pressure downstream of the turbine could also be calculated based on experimentally determined operating behavior of the fuel-cell system.

Preferably, a temperature-detecting unit is arranged at a turbine input or upstream of the turbine input for detecting the temperature of exhaust air flowing into the turbine, wherein the control unit is designed to determine an absolute mass flow from the reduced mass flow knowing the temperature. Thus, the actual mass flow can be compared to a specified minimum mass flow and regulated accordingly. This can be particularly useful for monitoring the safe operation of the fuel-cell system.

In an advantageous embodiment, the control unit is designed to activate the anode-purging valve such that a maximum possible amount of hydrogen from the momentary mass flow can be safely diluted during this operation. Thus, the concentration of hydrogen in the exhaust air can be directly limited.

Furthermore, it is advantageous when the compressor is additionally connected to an electric motor, wherein the electric motor is designed to provide a speed signal. The control unit can be designed to support the determination of the momentary mass flow with the speed signal. As explained above, this facilitates the finding of the momentary operating point of the turbine in the turbine characteristic map. The compressor could be connected to an electric motor, which is coupled to the at least one fuel cell via an inverter. By using a turbine in combination with the electric motor, the efficiency of the fuel-cell system can be further improved. In particular, modern brushless electric motors permit a simple transmission of a momentary speed.

It is particularly advantageous when the pressure at the turbine output is calculated with a known ambient pressure and a known pressure drop characteristic of the exhaust-air system. Using a pressure measurement at the turbine input, the expansion ratio through the turbine can then also be calculated. Alternatively, the pressure-detecting unit can also comprise, for example, two pressure sensors, one at the turbine input and one at the turbine output. As a result, the expansion ratio can be determined. This is because the control unit of the fuel-cell system will in any case detect the ambient pressure. With this information, as well as a relative pressure, the absolute pressure can then be calculated. In this respect, it is irrelevant whether absolute or relative pressure sensors are used.

In one advantageous embodiment, the control unit is designed to determine an expansion ratio through the turbine from the pressure at the turbine input and a calculation value of the pressure at the turbine output. With a known operating behavior of the fuel-cell system, knowledge of the pressure at the turbine input is sufficient for determining the expansion ratio. In particular, if the turbine output is directly coupled to the environment or if a pressure sensor already arranged in the exhaust-air line is used, the actual expansion ratio through the turbine can be determined.

It is further advantageous when the control unit is designed to determine the ambient pressure. The flow path located between the turbine output and the environment has a flow resistance that is dependent on the configuration. When determining the mass flow, a pressure difference over the stated flow value could be determined iteratively by individual successive calculation steps, which depends in particular on a mass flow determined in a previous calculation step.

Particularly preferably, the control unit is designed to determine the shortfall of a boundary line in the turbine characteristic map in order to validate the achievement of the minimum mass flow. For this purpose, the calculation of the actual mass flow is not required, so that the temperature at the turbine input does not necessarily have to be measured. The boundary line only relates to the reduced mass flow.

Furthermore, the control unit could be further designed to carry out a model-based simulation of the turbine for determining the mass flow, which is tracked at least by means of the measured pressure and the measured temperature of the actual turbine. The simulation can be a numerical simulation illustrating a simplified mapping of the fuel-cell system. It could be designed to mathematically depict the turbine in particular. By tracking the model using measured parameters, non-measured, unknown parameters can be obtained from the simulation.

The invention further relates to a method for operating a fuel-cell system having at least one fuel cell, an oxidant line, a compressor, an exhaust-air line, a turbine which is arranged in the exhaust-air line and is coupled to the compressor, an anode-purging line which is connected to the exhaust-air line and has an anode-purging valve, and a control unit. The method is characterized in that a pressure-detecting unit is coupled at least to the turbine input or a component lying upstream and detects a pressure of the exhaust air flowing into the turbine, in that the control unit determines a reduced mass flow of the exhaust air from the pressure upstream of the turbine and a specified turbine characteristic map, and in that the control unit activates the compressor and/or the turbine so as to achieve a minimum mass flow of the exhaust air. The features set forth above for the system are to be realized analogously by way of the method.

### BRIEF DESCRIPTION OF THE DRAWINGS

Shown are:

FIG. 1 a schematic illustration of the fuel-cell system;

FIG. 2 a schematic illustration of a swallowing characteristic of the turbine;

FIG. 3 a schematic illustration of a boundary line in a characteristic map of the turbine without consideration of turbine speed.

### DETAILED DESCRIPTION

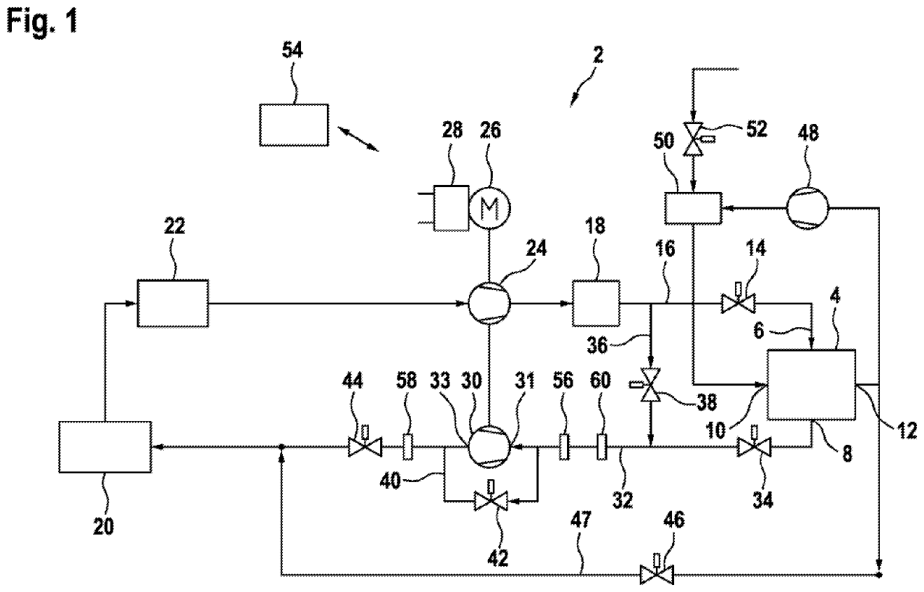

FIG. 1 shows a fuel-cell system 2 in a schematic illustration. The fuel-cell system 2 has a fuel cell 4 comprising an air input 6, an exhaust output 8, a hydrogen input 10, and a hydrogen output 12. The air input 6 is connected to an oxidant line designed as an air line 16 via a first shut-off valve 14. The first shut-off valve 14 can allow for an air supply to the fuel cell 4 and can disrupt it as needed. An intercooler 18 cools compressed air before it enters the fuel cell 4. Air enters a compressor 24 from the environment 20, for example by way of a particulate filter 22. This is coupled for example to an electric motor 26, which is supplied with electrical voltage via an inverter 28, which voltage is provided, for example, by the fuel cell 4.

The compressor 24 is further coupled to a turbine 30 arranged in an exhaust-air line 32 and having a turbine input 31 and a turbine output 33. The exhaust-air line 32 is arranged downstream of the cathode output 8 via a second shut-off valve 34. A cathode by-pass 36 is further provided between the air line 16 and the exhaust-air line 32, which is selectively activatable via a first bypass valve 38. The exhaust-air system 23 is arranged behind the turbine

An anode-purging valve 46 is coupled to the anode output 12 and the exhaust-air line 35 in order to purge nitrogen and water from the anode output 12, as needed, into the exhaust-air line 32 via an anode-purging line 47. Further, hydrogen present at the anode output 12 is recirculated to the anode input 10 via a second compressor 48 and a jet pump 50. Fresh hydrogen from a pressure tank 51, not shown, is mixed in via a throttle valve 52.

A control unit 54 is preferably coupled to all active elements, i.e., the valves 14, 34, 38, 42, 52, and the inverter 28, and is designed to activate the operation of the fuel-cell system 2 by activating these components. Furthermore, the control unit is coupled for example to a first pressure sensor 56 upstream of the turbine 30, as well as to a second pressure sensor 58 downstream of the turbine 30. Further, upstream of the turbine, there is arranged a temperature sensor 60 that is also connected to the control unit 54.

The control unit 54 is designed to determine a momentary mass flow of the exhaust air from the measured temperature of the exhaust air in the exhaust-air line 32, the pressure upstream of the turbine 30, and a turbine characteristic map associated with the turbine 30. The control unit 54 is thus enabled to activate the valve 46 as a function of the momentary mass flow, so that, when purging the anode of the fuel cell 4, the hydrogen concentration in the exhaust air does not exceed a certain value, for example 4%.

The inverter 28 and/or the electric motor 26 can further be designed so as to transmit a speed signal to the control unit 54. This simplifies the control unit 54 in the selection of a matching characteristic from the turbine characteristic map.

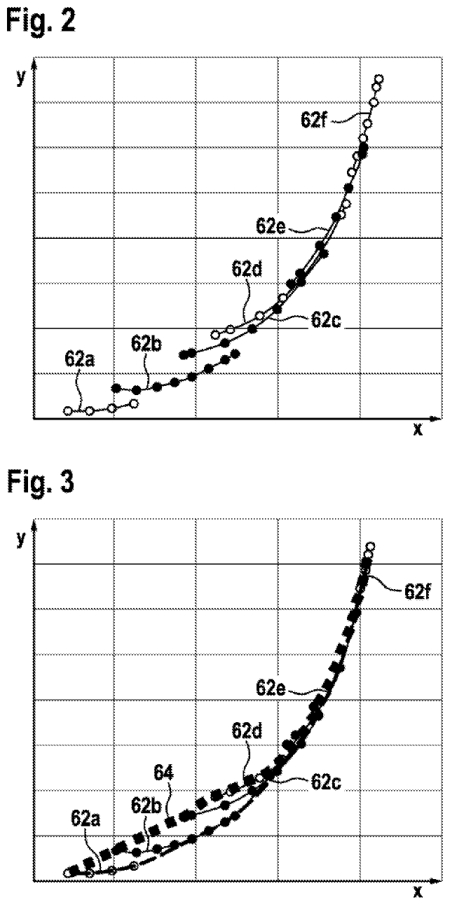

FIG. 2 shows an exemplary swallowing characteristic of the turbine 30. A plurality of curves 62a to 62f are shown here. Each of these characteristic curves is generated for a specific speed of the turbine 30. The y-axis shows the expansion ratio through the turbine 30, while the x-axis is the reduced mass flow at a reference temperature. Based on the knowledge of a speed as well as the expansion ratio, the reduced mass flow can consequently be read. Through the conversion as set forth above, the actual mass flow can be calculated knowing the actual temperature in the exhaust-air line 32 measured by the temperature sensor 60 and the pressure upstream of the turbine 30 measured by the first pressure sensor 56.

FIG. 3 shows a possible boundary line 64, which, in order to reduce the hydrogen concentration, should not be exceeded to the left or above, for which purpose no or no sensible speed signal must be present.

1. A fuel-cell system (2) having at least one fuel cell (4), an oxidant line (16), a compressor (24), an exhaust-air line (32), a turbine (30) which is arranged in the exhaust-air line (32) and is coupled to the compressor (24), an anode-purging line (47) which is connected to the exhaust-air line (32) and has an anode-purging valve (46), and a control unit (54), wherein a pressure-detecting unit (56, 58) is coupled at least to the turbine input (31) or a component lying upstream and is configured to detect a pressure of the exhaust air flowing into the turbine (30), in that the control unit (54) is configured to ascertain a reduced mass flow of the exhaust air from the pressure upstream of the turbine (30) and a specified turbine characteristic map, and in that the control unit (54) is configured to activate the compressor (24) and/or the turbine (30) so as to achieve a maximum water flow concentration.

2. The fuel-cell system (2) according to claim 1, wherein a temperature-detecting unit (60) is arranged at a turbine input (31) or upstream of the turbine input (31) for detecting the temperature of exhaust air flowing into the turbine (30) and in that the control unit (54) is configured to determine an absolute mass flow from the reduced mass flow knowing the temperature.

3. The fuel-cell system (2) according to claim 1, wherein the control unit (54) is configured to activate the anode-purging valve (46) and to regulate the mass flow when purging an anode of the at least one fuel cell (4).

4. The fuel-cell system (2) according to claim 1, wherein the compressor (24) is additionally connected to an electric motor (26), wherein the electric motor (26) is configured to provide a speed signal, and in that the control unit (54) is configured to support the determination of the momentary mass flow with the speed signal.

5. The fuel-cell system (2) according to claim 1, wherein the pressure-detecting unit (56, 58) comprises a differential pressure sensor or two pressure sensors (56, 58) and is configured for detecting the pressure drop between the turbine input (31) and a turbine output (33).

6. The fuel-cell system (2) according to claim 1, wherein the control unit (54) is configured to determine an expansion ratio through the turbine (30) from the pressure at the turbine input (31) and an estimated value of the pressure at the turbine output (33).

7. The fuel-cell system (2) according to claim 6, wherein the control unit (54) is configured to replace the estimated value with an ambient pressure measured by means of an ambient pressure sensor and the known pressure drop characteristic of the exhaust-air system.

8. The fuel-cell system (2) according to claim 1, wherein the control unit (54) is configured to determine the shortfall of a boundary line (64) in the turbine characteristic map in order to validate that the minimum mass flow has been achieved.

9. The fuel-cell system (2) according to claim 1, wherein the control unit (54) is configured to carry out a model-based simulation of the turbine for determining the mass flow, which is tracked at least by means of the measured pressure and the measured temperature of the actual turbine (30).

10. A method for operating a fuel-cell system (2) having at least one fuel cell (4), an oxidant line (16), a compressor (24), an exhaust-air line (32), a turbine (30) which is arranged in the exhaust-air line (32) and is coupled to the compressor (24), an anode-purging line (47) which is connected to the exhaust-air line (32) and has an anode-purging valve (46), and a control unit (54), wherein a pressure-detecting unit (56, 58) is coupled at least to the turbine input (31) or a component lying upstream and detects a pressure of the exhaust air flowing into the turbine (30), the method comprising:
determining, via the control unit (54), a reduced mass flow of the exhaust air from the pressure upstream of the turbine (30) and a specified turbine characteristic map, and
activating, via the control unit (54), the compressor and/or the turbine (30) so as to achieve a minimum mass flow of the exhaust air.
